(19) United States
(12) Patent Application Publication
(10) Pub. No.: US 2003/0095293 A1
(43) Pub. Date: May 22, 2003

(54) Image reading method and apparatus, and storage medium

(76) Inventor: Hiroyuki Wada, Kanagawa (JP)

Correspondence Address: MORGAN & FINNEGAN, L.L.P., 345 Park Avenue, New York, NY, 10154, US

(21) Appl. No.: 09/731,270

(22) Filed: Dec. 6, 2000

(30) Foreign Application Priority Data
Dec. 8, 1999 (JP) 11-348789

(51) Int. Cl. H04N 1/04

(52) U.S. Cl. 358/487

(57) ABSTRACT

This invention has as its object to provide an image reading method and apparatus capable of obtaining a high-quality image at an arbitrary scan resolution. To achieve this object, in scanning an image on a transparent original at a resolution other than a preset resolution and correcting the image, a system controller (20) controls to temporarily receive the image at the preset resolution higher than the resolution, correct the image, and interpolate the image.

### FIELD OF THE INVENTION

The present invention relates to an image reading method and apparatus for reading an image of a transparent original such as a developed photographic film, and a storage medium which stores a control program for controlling the image reading apparatus.

### BACKGROUND OF THE INVENTION

In general, a conventional image reading apparatus (film scanner) of this type irradiates a transparent original such as a microfilm or photographic film by an illumination optical system from the backside of the transparent original, projects the transmitted light on the imaging surface of a photoelectric conversion element via a projection optical system to form an image, and photoelectrically converts the image by the photoelectric conversion element to electrically convert image information of the transparent original.

In this conventional apparatus, however, dust attached to the illumination optical system and projection optical system, and dust or a scratch on a transparent original appear as black spots on read image data, resulting a low-quality image.

FIGS. 7A and 7B are views schematically showing the influence of dust or a scratch described above on image data and an output image. FIG. 7A shows a case wherein the transparent original is a reversal film, and FIG. 7B is a case wherein the transparent original is a negative film.

In FIG. 7A, a photographed object image (positive image) of a reversal film is read by a scanner (film scanner) serving as an image reading apparatus, and the read image signal is subjected to gamma correction and output as a positive image visible to the human eye.

In FIG. 7B, a photographed object image (negative image) of a negative film is read by a scanner (film scanner) serving as an image reading apparatus, and the read image signal is subjected to reversal processing and gamma correction (image processing) and output as a positive image visible to the human eye.

As shown in FIGS. 7A and 7B, when a transparent original is read by a scanner by image conversion, dust or a scratch appears as a black spot on an image signal of an output image (positive image) regardless of whether the transparent original is a reversal film or negative film.

As for the reversal film, as shown in FIG. 7A, the image signal is directly subjected to image processing such as gamma correction, and output to an output device such as a printer. The influence of dust or a scratch directly appears as a black spot on an output image (positive image).

As for the negative film, as shown in FIG. 7B, an-image signal read by the scanner is subtracted from an image signal read at a full level to convert the negative image into a positive image. The influence of dust or a scratch appears as a white bright spot on an output image (positive image).

To prevent this, there has already been proposed an image reading apparatus (film scanner) which gives attention to the transmittance characteristic of a transparent original to infrared light, detects only dust or a scratch as described above which degrades an image, by infrared light having transmitted through the transparent original, and corrects read image data on the basis of the detected dust information.

Examples of this image reading apparatus are disclosed in Japanese Patent Publication No. 7-97402 (to be referred to as the first prior art hereinafter), and Japanese Patent No. 2559970 (to be referred to as the second prior art hereinafter).

The first prior art corrects a pixel recognized to have dust or a scratch by properly selecting its peripheral image information.

The second prior art performs not only image correction of image data around a pixel recognized to have dust or a scratch, but also image correction based on infrared light data of the region of the pixel recognized to have dust or a-scratch. Further, the second prior art properly uses these image correction methods in accordance with the level of infrared light data.

However, these prior arts discretely set image pitches in the main scanning direction and subscanning direction, and cannot create image data in which the influence of dust or a scratch is corrected at another resolution.

### SUMMARY OF THE INVENTION

The present invention has been made to overcome the conventional drawbacks, and has as its first object to provide an image reading method and apparatus capable of obtaining a high-quality image at an arbitrary scan resolution.

It is the second object of the present invention to provide a storage medium which stores a control program for controlling the image reading apparatus of the present invention.

To achieve the first object, according to the first aspect of the image reading method of the present invention, an image reading method of reading an image of a transparent original is characterized by comprising the step of, in reading the image at a resolution other than a set resolution determined by a scan pitch of the transparent original and a pixel pitch of a line sensor, performing control of receiving the image at the set resolution in advance, correcting an image of a region which requires correction, and performing resolution conversion in order to obtain an image at a desired resolution.

To achieve the first object, according to the first aspect of the image reading apparatus of the present invention, an image reading apparatus for reading an image of a transparent original is characterized by comprising control means for, in reading the image at a resolution other than a set resolution determined by a scan pitch of the transparent original and a pixel pitch of a line sensor, performing control of receiving the image at the set resolution in advance, correcting an image of a region which requires correction, and performing resolution conversion in order to obtain an image at a desired resolution.

To achieve the first object, according to the second aspect of the image reading method of the present invention, an image reading method is characterized by comprising the scan step of scanning a transparent original, the light-emitting step of emitting light for irradiating the transparent original held to be scannable in the scan step, the imaging step of forming the light having passed through the transparent original into an image by an optical system, the light detection step of detecting the light having passed through the optical system, the storage step of storing a light detection result in the light detection step, the calculation step of comparing a stored content in the storage step, the determination step of determining whether a region requires correction, from the light detection result in the light detection step, the correction step of correcting image data in the region which requires correction, and the control step of, when image data is to be obtained at a second resolution other than a plurality of first detectable resolutions determined in the scan step and the light detection step, performing control of correcting the image data at one resolution out of the plurality of first resolutions in the correction step, and then converting the resolution into the second resolution.

To achieve the first object, according to the second aspect of the image reading apparatus of the present invention, an image reading apparatus is characterized by comprising scan means for scanning a transparent original, light-emitting means for emitting light for irradiating the transparent original held to be scannable by the scan means, imaging means for forming the light having passed through the transparent original into an image by an optical system, light detection means for detecting the light having passed through the optical system, storage means for storing a light detection result by the light detection means, calculation means for comparing a stored content in the storage means, determination means for determining whether a region requires correction, from the light detection result by the light detection means, correction means for correcting image data in the region which requires correction, and control means for, when image data is to be obtained at a second resolution other than a plurality of first detectable resolutions determined by the scan means and the light detection means, performing control of correcting the image data at one resolution out of the plurality of first resolutions by the correction means, and then converting the resolution into the second resolution.

To achieve the second object, according to the first aspect of the storage medium of the present invention, a storage medium which stores a control program for controlling an image reading apparatus for reading an image of a transparent original, and is readable by information reading means is characterized in that the control program comprises a control module for, in reading the image at a resolution other than a set resolution determined by a scan pitch of the transparent original and a pixel pitch of a line sensor, performing control of receiving the image at the set resolution in advance, correcting an image of a region which requires correction, and performing resolution conversion in order to obtain an image at a desired resolution

To achieve the second object, according to the second aspect of the storage medium of the present invention, a storage medium which stores a control program for controlling an image reading apparatus for reading an image of a transparent original, and is readable by information reading means is characterized in that the control program comprises a scan module for scanning a transparent original, a light-emitting module for emitting light for irradiating the transparent original held to be scannable, an imaging module for forming the light having passed through the transparent original into an image by an optical system, a light detection module for detecting the light having passed through the optical system, a storage module for storing a light detection result by the light detection module, a calculation module for comparing a stored content in the storage module, a determination module for determining whether a region requires correction, from the light detection result by the light detection module, a correction module for correcting image data in the region which requires correction, and a control module for, when image data is to be obtained at a second resolution other than a plurality of first detectable resolutions determined by the scan module and the light detection module, performing control of correcting the image data at one resolution out of the plurality of first resolutions by the correction module, and then converting the resolution into the second resolution.

Other objects and advantages besides those discussed above shall be apparent to those skilled in the art from the description of a preferred embodiment of the invention which follows. In the description, reference is made to accompanying drawings, which form a part hereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a block diagram showing the system configuration having an image reading apparatus according to an embodiment of the present invention;

FIG. 2 is a perspective view showing the internal arrangement of the image reading apparatus according to the embodiment of the present invention;

FIG. 3 is a main flow chart showing the operation flow of the whole image reading apparatus according to the embodiment of the present invention;

FIG. 4 is a flow chart of a subroutine showing the prescan operation flow of the image reading apparatus according to the embodiment of the present invention;

FIG. 5 is a flow chart of a subroutine showing the main scan operation flow of the image reading apparatus according to the embodiment of the present invention;

FIG. 6 is a flow chart of a subroutine showing the eject operation flow of the image reading apparatus according to the embodiment of the present invention; and

FIGS. 7A and 7B are schematic views showing the influence of dust or a scratch in a conventional image reading apparatus.

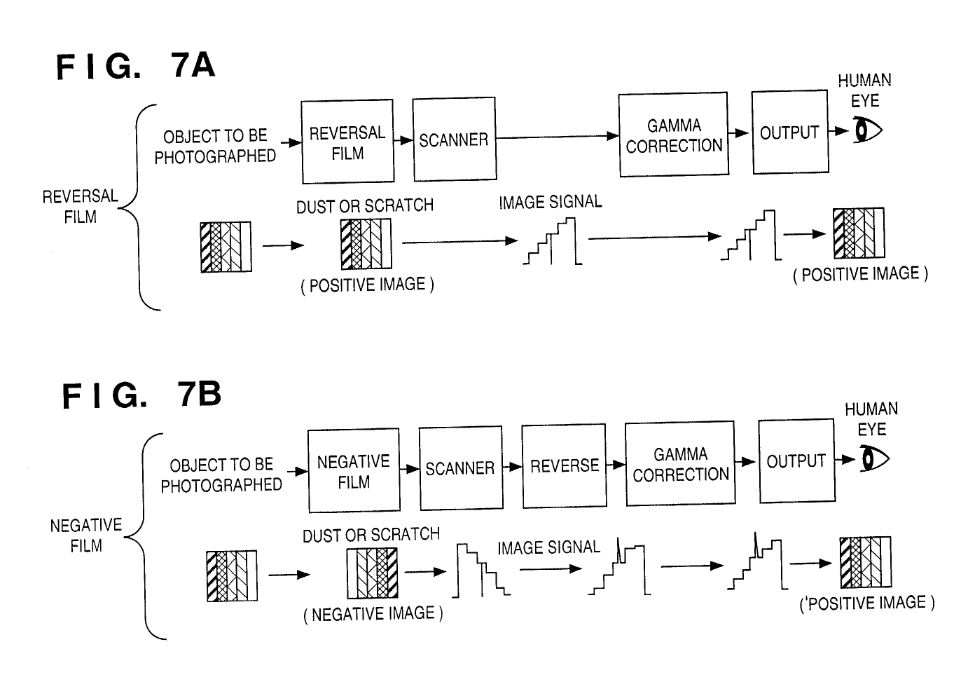

### DETAILED DESCRIPTION OF THE PREFERRED EMBODIMENT

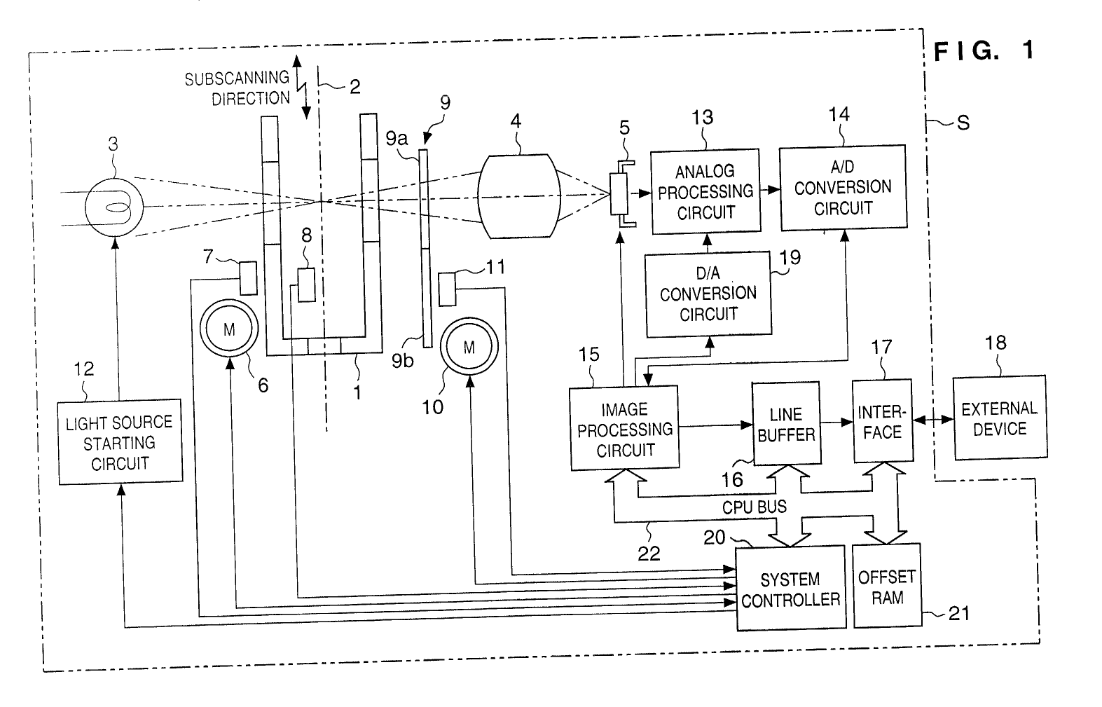

An embodiment of the present invention will be described below with reference to FIGS. 1 to 6.

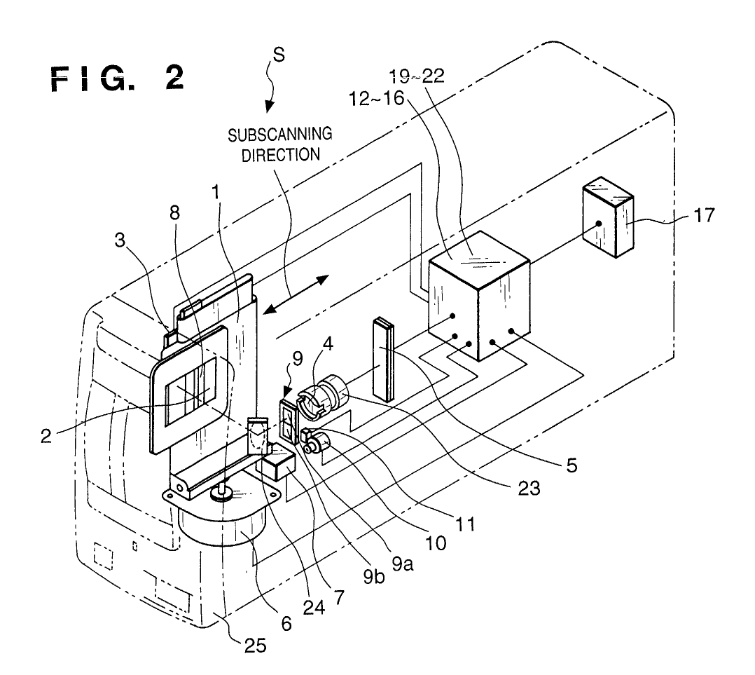

FIG. 1 is a block diagram showing the system configuration having an image reading apparatus according to the embodiment, and FIG. 2 is a perspective view showing the internal arrangement of the image reading apparatus according to the embodiment. In FIGS. 1 and 2, reference symbol S denotes an image reading apparatus (film scanner) according to the embodiment. Reference numeral 1 denotes a carriage for holding a transparent original holder (transparent original adapter) or the like; 2, a transparent original such as a film; 3, a light source for irradiating the transparent original 2; 4, an imaging lens; 5, a line sensor (image sensing element); 6, a subscanning motor (M) for driving the carriage 1 in the subscanning direction; 7, a carriage position detection sensor for detecting the position of the carriage 1; 8, a transparent original density sensor; 9, an optical filter having an infrared light cut filter 9a and visible light cut filter 9b; 10, a filter motor (M) for switching the optical filter 9 between an infrared light cut state and a visible light cut state; 11, a filter position detection sensor for detecting the position of the optical filter 9; 12, a starting circuit for the light source 3; 13, an analog processing circuit; 14, an A (Analog)/D (Digital) conversion circuit; 15, an image processing circuit; 16, a line buffer; 17, an interface; 18, an external device such as a personal computer; 19, a D (Digital)/A (Analog) conversion circuit; 20, a system controller; 21, an offset RAM (Random Access Memory); and 22, a CPU (Central Processing Unit) bus.

In FIG. 2, reference numeral 23 denotes a lens holder which holds the imaging lens 4; 24, a mirror for deflecting the optical path; and 25, an outer housing of the image reading apparatus S.

The mirror 24 is not shown in FIG. 1. This is because deflecting the optical path by the mirror 24 realizes a more compact layout, but the presence/absence of the mirror 24 is irrelevant to the gist of the present invention. In extreme cases, it is irrelevant here whether the mirror 24 exists or does not exist, or a plurality of mirrors 24 exist.

The operation of the system for converting an image of the transparent original 2 into an electrical signal and inputting the electrical signal to the external device 18 by using the image reading apparatus S according to this embodiment with the above arrangement will be explained.

The transparent original 2 is fixed to and held by the carriage 1 via a transparent original holder (not shown), and coupled to be drivable by the subscanning motor 6 via a power transmission mechanism (not shown) such as a reduction gear. The minimum feed pitch of the power transmission mechanism is appropriately set in accordance with the read resolution of the transparent original 2.

The light source 3 is comprised of a line-shaped fluorescent tube containing an inert gas such as xenon, and mercury, and arranged almost parallel to the main scanning direction of the line sensor 5. The light source 3 emits light having waveforms corresponding to at least blue, green, and red. The light source 3 as a fluorescent tube is turned on by the light source starting circuit 12 serving as a so-called inverter circuit.

The imaging lens 4 forms light irradiating the transparent original 2 from the light source 3 into an image on the line sensor 5. The distance between the optical axes of the imaging lens 4 and line sensor 5 is adjusted in advance, and thus an image of the transparent original 2 is formed on the line sensor 5 at a predetermined magnification. The inclinations of the transparent original 2 and line sensor 5 in the main scanning direction are also adjusted in advance to avoid distortion of an output image. When the position of the transparent original 2 along the optical axis changes for each adapter or is not determined with high precision, or the focal depth of the imaging lens 4 is short, the imaging lens 4 is guided along the optical axis to constitute a focus adjustment system using a motor or the like. This embodiment eliminates the focal adjustment system.

As the line sensor 5, the embodiment uses a line sensor having three lines (R, G, and B). In this line sensor, respective light-receiving portions are arranged parallel to each other at a predetermined interval. An image signal generated by the line sensor 5 is converted into a digital signal by the A/D conversion circuit 14, and converted into image data by the image processing circuit 15. This image data can be added to the analog processing circuit 13 via the D/A conversion circuit 19 to attain a signal of a stable black level.

The image processing circuit 15 is formed from a gate array or the like. The image processing circuit 15 performs various processes such as digital AGC (Automatic Gain Control) processing, shading correction processing, γ correction processing, color data synthesis processing, resolution/magnification conversion processing, filter processing, masking processing, binarization/AE (AutoExposure) processing, negative/positive reversal processing, and mirror image processing on the basis of digital image data converted by the A/D conversion circuit 14. Further, the image processing circuit 15 outputs an operation clock for the line sensor 5 and a sample timing signal for the A/D conversion circuit 14.

Digital AGC processing adjusts the dynamic range of an input signal of each color. Shading correction processing corrects nonuniformity in the light quantity of the light source 3, the transmittance of the imaging lens 4, or the sensitivity of the line sensor 5. γ correction processing converts an input gray level into an output gray level while adjusting the contrast of an image. Color data synthesis processing temporarily stores image data in the offset RAM 21, and after all the data are stored, outputs the data as 1-line color data in order to correct a shift in the positional interval between the respective light-receiving portions of the line sensor 5 described above. Resolution/magnification conversion processing executes data decimation and addition processing for setting based on input of a conversion parameter from the system controller 20. This is performed in accordance with a command from the external device 18.

Filter processing selectively performs various processes such as main scanning interpolation processing, subscanning interpolation processing, averaging processing, smoothing processing, and edge processing in accordance with the gray level and resolution. Masking processing performs processing by correcting unwanted light from the light source 3, and multiplying each color data by a correction coefficient in order to make the color data close to an ideal color characteristic. Binarization/AE (AutoExposure) processing performs processing in accordance with a command from the external device 18 particularly using data of a green channel. Negative/positive reversal processing performs processing in accordance with an instruction from the system controller 20 when a negative film is set as the transparent original 2. This processing is implemented by, e.g., an exclusive-OR circuit. Mirror image processing performs processing by reversely reading out data written in the offset RAM 21 in accordance with a command from the external device 18.

The offset RAM 21 is prepared as a working area for executing these image processes, and temporarily stores image data. The line buffer 16 temporarily stores image data having undergone processing by the image processing circuit 15, and outputs image data to the external device 18 via the interface 17 such as a SCSI controller.

The system controller 20, image processing circuit 15, line buffer 16, interface 17, and offset RAM 21 are connected by the CPU bus 22 made up of an address bus and data bus, as shown in FIG. 1. This allows data communication between the respective circuits.

In this arrangement, the user of the image reading apparatus S gives a command to the system controller 20 via the external device 18. The command from the user is transmitted to the system controller 20 via the interface 17. More specifically, the user command includes the type of transparent original 2, the image read range, the read resolution, a main scan command, and whether to perform dust/scratch correction processing. Based on these user commands and outputs from various detection circuits (sensors), the system controller 20 executes electrical preparation and processing in accordance with a properly programmed flow.

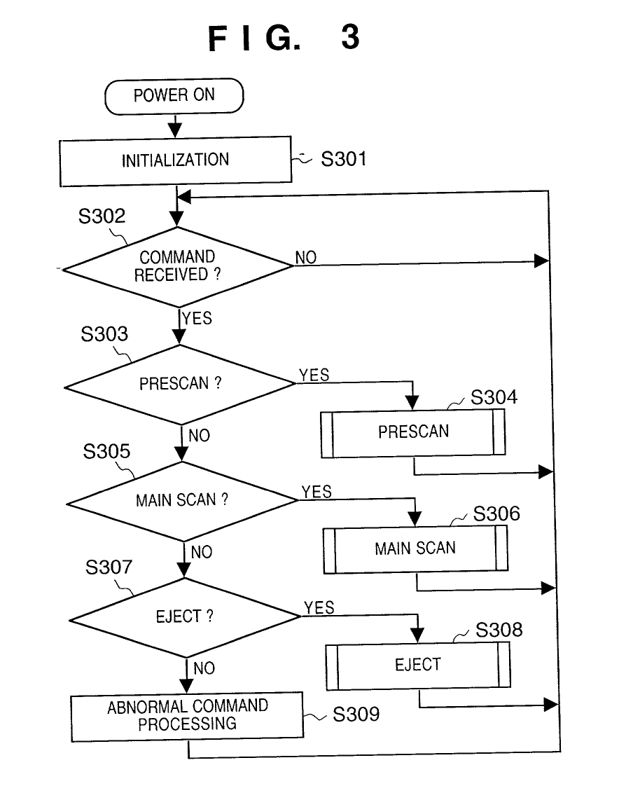

An operation of converting an image of the transparent original 2 into an electrical signal will be explained with reference to FIGS. 3 to 6.

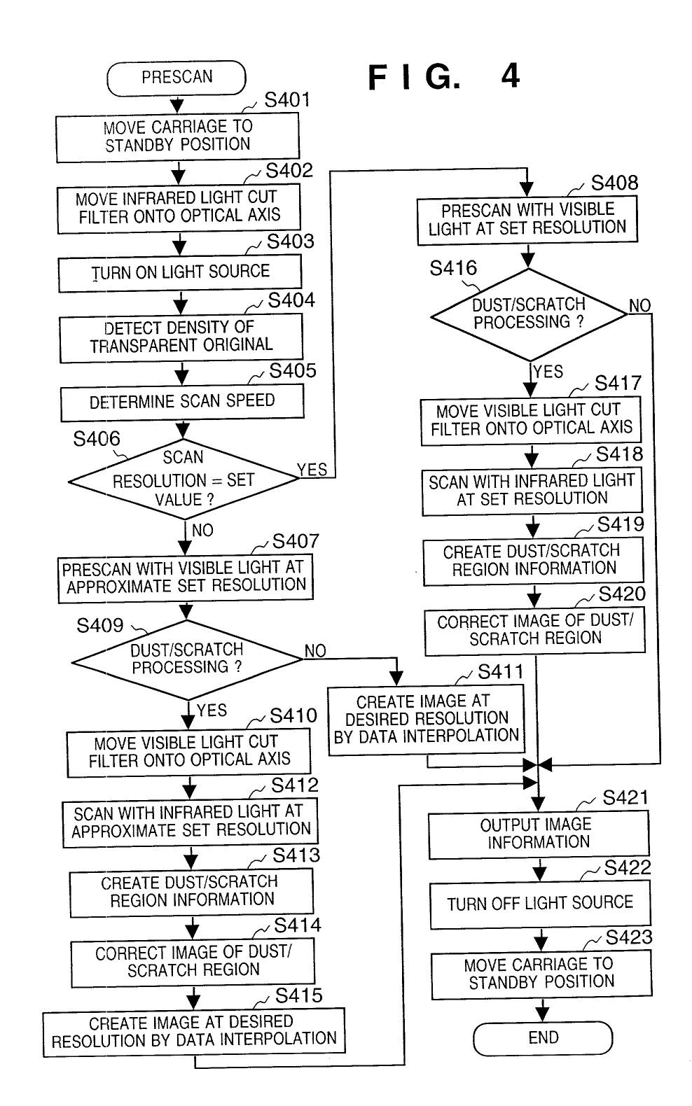

FIG. 3 is a flow chart showing the main routine of the operation flow of the whole image reading apparatus S according to the embodiment. FIGS. 4 to 6 are flow charts, respectively, showing the subroutines of the operation flows of a prescan sequence, main scan sequence, and eject sequence in the image reading apparatus S according to this embodiment.

The main flow will be described with reference to FIG. 3. Assume that the external device 18 such as a personal computer has already been turned on.

If the main body of the image reading apparatus S is turned on, the system controller 20 performs the various initialization operations in step S301. The initialization operations include memory check of the offset RAM 21, driving check of the various motors 6 and 10, black level correction, shading correction, and initial setting of the SCSI controller. After initialization in step S301 ends, the flow shifts to step S302.

In step S302, the flow stands by for reception of a command from the external device 18. If the user inputs an operation command representing an operation to be executed by the image reading apparatus S via the application of the external device 18, the standby state is canceled, and the flow shifts to step S303.

In steps S303 to S308, the command from the external device 18 is determined.

In step S303, whether the command from the external device 18 is a prescan command is checked. If YES in step S303, the flow advances to step S304; or if NO, to step S305.

A prescan sequence is performed in step S304, and then the flow returns to step S302 to wait for reception of a command again. Details of the prescan sequence in step S304 will be described with reference to FIG. 4.

In step S305, whether the command from the external device 18 is a main scan command is checked. If YES in step S305, the flow advances to step S306; or if NO, to step S307.

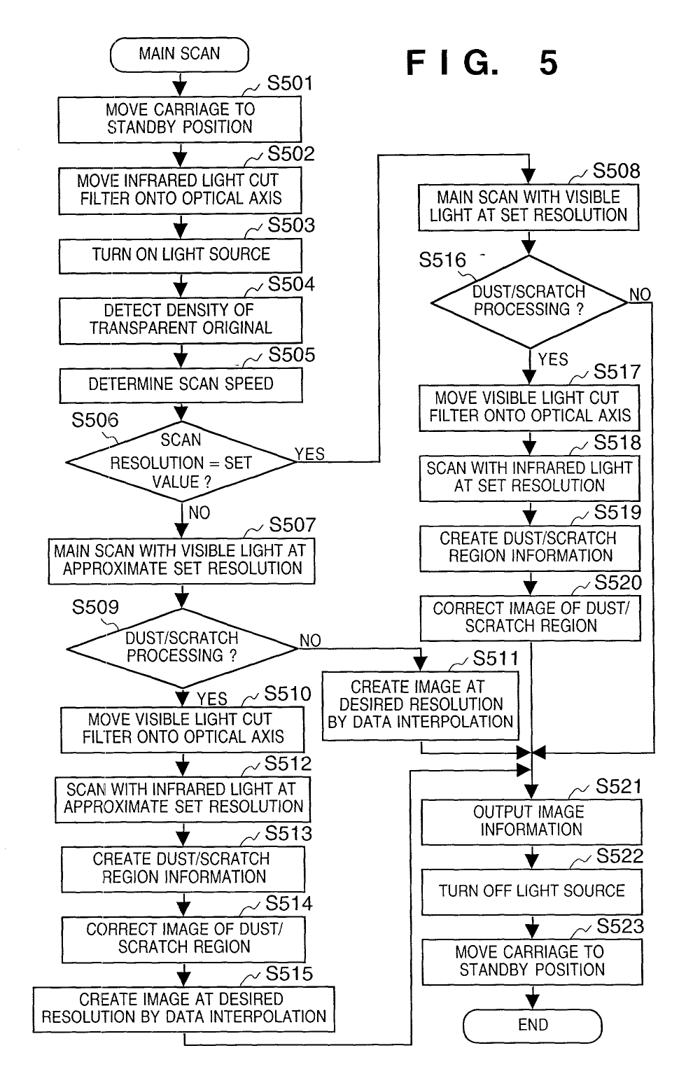

A main scan sequence is performed in step S306, and then the flow returns to step S302 to wait for reception of a command again. Details of the main scan sequence in step S306 will be described with reference to FIG. 5.

In step S307, whether the command from the external device 18 is an eject command is checked. If YES in step S307, the flow advances to step S308; or if NO, to step S309.

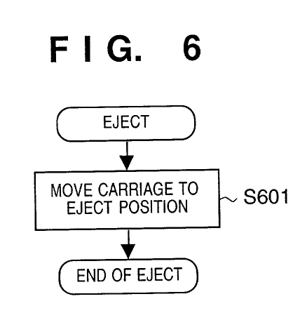

An eject sequence is performed in step S308, and then the flow returns to step S302 to wait for reception of a command again. Details of the eject sequence in step S308 will be described with reference to FIG. 6.

In step S309, it is determined that a command (abnormal command) which cannot be detected by the command reception content check in steps S303 to S307 has been received. After abnormal command processing is executed, the flow returns to step S302 to wait for command reception again. As abnormal command processing in step S309, e.g., an abnormal warning is issued to the external device 18 to notify the user of the abnormality with a monitor or the like.

Various subroutines shown in FIGS. 4 to 6 will be explained.

The prescan sequence will be described with reference to FIG. 4.

After the carriage 1 is moved to an initial position where the carriage 1 stands by in step S401, the flow shifts to step S402. In this case, the initial position of the carriage 1 is a start position in scanning an image of the transparent original 2, i.e., a state in which either image end of the transparent original 2 or its vicinity is on the optical axis.

In step S402, the position of the filter 9 is detected by the filter position detection sensor 11, and read by the system controller 20. In order to insert the infrared light cut filter 9a on the optical axis, the filter motor 10 is driven to move the infrared light cut filter 9a onto the optical axis. After processing in step S402 ends, the flow advances to step S403.

The system controller 20 drives the light source starting circuit 12 to turn on the light source 3 in step S403, and then the flow shifts to step S404.

In step S404, the subscanning motor 6 is driven to position the optical axis within the image range (e.g., near the center of the transparent original 2) of the transparent original 2. Light quantity data is input by the line sensor 5, the gain is adjusted to set the light quantity value to a proper value, and exposure adjustment is done. After that, the transparent original 2 is moved to the initial position again, and the flow shifts to step S405.

In step S405, the driving speed of the subscanning motor 6 in prescan is determined from the processing result in step S404. More specifically, when the light quantity is very small, and no sufficient light quantity can be obtained by only gain adjustment, the driving speed of the subscanning motor 6 is decreased. After processing in step S405 ends, the flow advances to step S406.

In step S406, whether the scan resolution of the command upon command reception (step S302 in FIG. 3) from the external device 18 is a preset value is checked. If NO in step S406, the flow shifts to step S407; or if YES, to step S408.

In step S407, the scan resolution is not the set value, so that scan operation for prescan starts at a set resolution higher than (approximate to) a desired scan resolution. At this time, if the prescan range is designated by the command from the external device 18, it is set in the image processing circuit 15 to scan. Image data obtained by this scan is stored in the offset RAM 21. After processing in step S407 ends, the flow advances to step S409.

In step S408, the scan resolution is the set value, so that scan operation for prescan starts at the set resolution. At this time, if the prescan range is designated by the command from the external device 18, it is set in the image processing circuit 15 to scan. Image data obtained by this scan is stored in the offset RAM 21. After processing in step S408 ends, the flow advances to step S416.

In step S409, whether a dust/scratch correction processing command is received upon command reception (step S302 in FIG. 3) from the external device 18 is checked. If YES in step S409, the flow advances to step S410; or if NO, to step S411.

In step S410, the position of the filter 9 is detected by the filter position detection sensor 11, and read by the system controller 20. In order to arrange the visible light cut filter 9b on the optical axis, the filter motor 10 is driven to move the visible light cut filter 9b onto the optical axis. After processing in step S410 ends, the flow advances to step S412.

In step S411, the image data created in step S407 is converted into a desired resolution to recreate the image data. This is realized by performing main scanning interpolation, subscanning interpolation, averaging, smoothing, edge processing, or the like by filter processing in the image processing circuit 15, as described above. Thereafter, the flow shifts to step S421 for outputting image data.

In step S412, scan is executed with infrared light at the same resolution as the one used to scan with visible light in step S407. At this time, if the prescan range is designated by the command from the external device 18, similar to steps S407 and S408, it is set in the image processing circuit 15 to scan. Image data obtained by this scan is stored in the offset RAM 21. After processing in step S412 ends, the flow advances to step S413.

In step S413, region information of dust or a scratch on the transparent original 2 is created on the basis of image information of infrared light received in step S412, and the flow shifts to step S414.

In step S414, image data within the region of dust or a scratch on the transparent original 2 that is created in step S413 is corrected (modified), and the flow shifts to step S415. The image data correction method includes the examples described in the prior art.

In step S415, the image data corrected in step S414 is converted into a desired resolution to recreate the image data. This is realized by performing main scanning interpolation, subscanning interpolation, averaging, smoothing, edge processing, or the like by filter processing in the image processing circuit 15, as described above. Then, the flow shifts to step S421 for outputting image data.

After visible light image data is created in step S408, whether a dust/scratch correction processing command is received upon command reception (step S302 in FIG. 3) from the external device 18 is checked in step S416, similar to step S409. If YES in step S416, the flow advances to step S417; or if NO, to step S421.

In step S417, the position of the filter 9 is detected by the filter position detection sensor 11, and read by the system controller 20. In order to insert the visible light cut filter 9b on the optical axis, the filter motor 10 is driven to move the visible light cut filter 9b onto the optical axis. Note that processing in step S417 is the same as processing in step S410. After processing in step S417 ends, the flow advances to step S418.

In step S418, scan is executed with infrared light at the set resolution. At this time, if the prescan range is designated by the command from the external device 18, similar to steps S407, S408, and S412, it is set in the image processing circuit 15 to perform scan. Image data obtained by this scan is stored in the offset RAM 21. After processing in step S418 ends, the flow advances to step S419.

In step S419, region information of dust or a scratch on the transparent original 2 is created on the basis of image information of infrared light received in step S418. Note that processing in step S417 is the same as processing in step S413. After processing in step S419 ends, the flow shifts to step S420.

In step S420, image data within the region of dust or a scratch on the transparent original 2 that is created in step S419 is corrected. The correction method includes the examples described in the prior art. Note that processing in step S420 is the same as processing in step S414. After processing in step S420 ends, the flow shifts to step S421.

In step S421, the image data obtained in step S411, S415, S416, or S420 is output to the external device 18 via the interface 17, and the flow shifts to step S422.

In step S422, the light source 3 is turned off in accordance with an instruction from the system controller 20, and the flow shifts to step S423.

In step S423, after a prescanned image is input, driving pulses to the subscanning motor 6 and line sensor 5 are stopped, and the transparent original 2 is moved to the initial position again where the transparent original 2 stands by. After that, this processing operation ends.

The prescan sequence ends with this operation, and the flow returns to the main routine in FIG. 3 again to enter the command reception standby state (step S302).

The main scan sequence will be explained with reference to FIG. 5.

The main scan sequence shown in FIG. 5 is basically the same as the prescan sequence in FIG. 4 described above. The main scan sequence has a larger range of choices of the image reception resolution.

The sequences in FIGS. 4 and 5 are different in that steps S407 and S408 in FIG. 4 are prescan with visible light, whereas steps S507 and S508 in FIG. 5 are main scan with visible light, and that the set value in step S506 of FIG. 5 is larger than the set value in step S406 of FIG. 4. However, steps S501 to S505 and steps S509 to S523 in FIG. 5 are the same as steps S401 to S405 and steps S409 to S423 in FIG. 4, and a detailed description thereof will be omitted.

The eject sequence will be explained with reference to FIG. 6.

In step S601, the subscanning motor 6 is driven to move the carriage 1 to an eject position, and this processing operation ends.

The eject sequence ends with this operation, and the flow returns to the main routine in FIG. 3 again to enter the command reception standby state (step S302).

The image reading apparatus according to the embodiment realizes the functions of the above-described embodiment by reading out and executing a control program stored in a storage medium by a computer. However, the present invention is not limited to this, and includes a case wherein an OS (Operating System) running on the computer performs part or all of actual processing on the basis of the instructions of the control program, and this processing realizes the functions of this embodiment.

As the storage medium which stores the control program, a floppy disk, hard disk, optical disk, magnetooptical disk, CD-ROM (Compact Disk Read Only Memory), CD-R (Compact Disk Recordable), magnetic tape, nonvolatile memory card, ROM chip, and the like can be used.

As has been described in detail above, the image reading method and apparatus of this embodiment scan at a resolution other than a preset resolution to correct the influence of dust or a scratch on a transparent original. In this case, an image is temporarily received at a preset resolution higher than the resolution to correct the influence of dust or a scratch on the transparent original, and then image interpolation processing is executed. This attains an effect that a high-quality image can be obtained at an arbitrary scan resolution.

The storage medium of this embodiment attains an effect that the image reading apparatus of the present invention can be smoothly controlled.

The present invention is not limited to the above embodiments and various changes and modifications can be made within the spirit and scope of the present invention. Therefore, to apprise the public of the scope of the present invention the following claims are made.

What is claimed is:

1. An image reading method of reading an image of a transparent original, comprising the step of, in reading the image at a resolution other than a set resolution determined by a scan pitch of the transparent original and a pixel pitch of a line sensor, performing control of receiving the image at the set resolution in advance, correcting an image of a region which requires correction, and performing resolution conversion in order to obtain an image at a desired resolution.

2. The method according to claim 1, wherein the transparent original includes a developed photographic film.

3. An image reading apparatus for reading an image of a transparent original, comprising control means for, in reading the image at a resolution other than a set resolution determined by a scan pitch of the transparent original and a pixel pitch of a line sensor, performing control of receiving the image at the set resolution in advance, correcting an image of a region which requires correction, and performing resolution conversion in order to obtain an image at a desired resolution

4. The apparatus according to claim 3, wherein the transparent original includes a developed photographic film.

5. An image reading method comprising:
the scan step of scanning a transparent original;
the light-emitting step of emitting light for irradiating the transparent original held to be scannable in the scan step;
the imaging step of forming the light having passed through the transparent original into an image by an optical system;
the light detection step of detecting the light having passed through the optical system;
the storage step of storing a light detection result in the light detection step;
the calculation step of comparing a stored content in the storage step; the determination step of determining whether a region requires correction, from the light detection result in the light detection step;
the correction step of correcting image data in the region which requires correction; and
the control step of, when image data is to be obtained at a second resolution other than a plurality of first detectable resolutions determined in the scan step and the light detection step, performing control of correcting the image data at one resolution out of the plurality of first resolutions in the correction step, and then converting the resolution into the second resolution.

6. The method according to claim 5, wherein the one resolution out of the plurality of first resolutions is higher than and nearest to the second resolution.

7. The method according to claim 5, wherein the light-emitting step comprises emitting visible light and infrared light.

8. The method according to claim 5, wherein the transparent original includes a developed photographic film.

9. An image reading apparatus comprising:
scan means for scanning a transparent original;
light-emitting means for emitting light for irradiating the transparent original held to be scannable by said scan means; imaging means for forming the light having passed through the transparent original into an image by an optical system;
light detection means for detecting the light having passed through the optical system;
storage means for storing a light detection result by said light detection means;
calculation means for comparing a stored content in said storage means;
determination means for determining whether a region requires correction, from the light detection result by said light detection means; correction means for correcting image data in the region which requires correction; and
control means for, when image data is to be obtained at a second resolution other than a plurality of first detectable resolutions determined by said scan means and said light detection means, performing control of correcting the image data at one resolution out of the plurality of first resolutions by said correction means, and then converting the resolution into the second resolution.

10. The apparatus according to claim 9, wherein the one resolution out of the plurality of first resolutions is higher than and nearest to the second resolution.

11. The apparatus according to claim 9, wherein said light-emitting means emits visible light and infrared light.

12. The apparatus according to claim 9, wherein the transparent original includes a developed photographic film.

13. A storage medium which stores a control program for controlling an image reading apparatus for reading an image of a transparent original, and is readable by information reading means, wherein the control program comprises a control module for, in reading the image at a resolution other than a set resolution determined by a scan pitch of the transparent original and a pixel pitch of a line sensor, performing control of receiving the image at the set resolution in advance, correcting an image of a region which requires correction, and performing resolution conversion in order to obtain an image at a desired resolution.

14. The medium according to claim 13, wherein the transparent original includes a developed photographic film.

15. A storage medium which stores a control program for controlling an image reading apparatus for reading an image of a transparent original, and is readable by information reading means, wherein the control program comprises:
a scan module for scanning a transparent original;
a light-emitting module for emitting light for irradiating the transparent original held to be scannable;
an imaging module for forming the light having passed through the transparent original into an image by an optical system;
a light detection module for detecting the light having passed through the optical system;
a storage module for storing a light detection result by the light detection module;
a calculation module for comparing a stored content in the storage module;
a determination module for determining whether a region requires correction, from the light detection result by the light detection module;
a correction module for correcting image data in the region which requires correction; and
a control module for, when image data is to be obtained at a second resolution other than a plurality of first detectable resolutions determined by the scan module and the light detection module, performing control of correcting the image data at one resolution out of the plurality of first resolutions by the correction module, and then converting the resolution into the second resolution.

16. The medium according to claim 15, wherein the one resolution out of the plurality of first resolutions is higher than and nearest to the second resolution.

17. The medium according to claim 15, wherein the light-emitting means emits visible light and infrared light.

18. The medium according to claim 15, wherein the transparent original includes a developed photographic film.

19. The medium according to claim 13, wherein the storage medium includes a floppy disk.

20. The medium according to claim 15, wherein the storage medium includes a floppy disk.

21. The medium according to claim 13, wherein the storage medium includes a hard disk.

22. The medium according to claim 15, wherein the storage medium includes a hard disk.

23. The medium according to claim 13, wherien the storage medium includes an optical disk.

24. The medium according to claim 15, wherein the storage medium includes an optical disk.

25. The medium according to claim 13, wherein the storage medium includes a magneto-optical disk.

26. The medium according to claim 15, wherein the storage medium includes a magneto-optical disk.

27. The medium according to claim 13, wherein the storage medium includes a CD-ROM (Compact Disk Read Only Memory).

28. The medium according to claim 15, wherein the storage medium includes a CD-ROM (Compact Disk Read Only Memory).

29. The medium according to claim 13, wherein the storage medium includes a CD-R (Compact Disk Recordable).

30. The medium according to claim 15, wherein the storage medium includes a CD-R (Compact Disk Recordable).

31. The medium according to claim 13, wherein the storage medium includes a magnetic tape.

32. The medium according to claim 15, wherein the storage medium includes a magnetic tape.

33. The medium according to claim 13, wherein the storage medium includes a nonvolatile memory card.

34. The medium according to claim 15, wherein the storage medium includes a nonvolatile memory card.

35. The medium according to claim 13, wherein the storage medium includes a ROM (Read Only Memory) chip.

36. The medium according to claim 15, wherein the storage medium includes a ROM (Read Only Memory) chip.
